(19) United States
(12) Patent Application Publication
(10) Pub. No.: US 2009/0232358 A1
(43) Pub. Date: Sep. 17, 2009

(54) Method and apparatus for processing an image

(76) Inventor: Geoffrey Mark Timothy Cross, Oxford (GB)

Correspondence Address: MILAN M. POPOVICH;CREATIVE PHYSICS LTD., 53 WESTFIELD ROAD, LEICESTER, LE3 6HU, GB

(21) Appl. No.: 12/382,021

(22) Filed: Mar. 6, 2009

(30) Foreign Application Priority Data
Mar. 11, 2008 (GB) GB0804466.1

(51) Int. Cl. G06K 9/00; G06K 9/68

(52) U.S. Cl. 382/103; 382/218; 382/170

(57) ABSTRACT

There is provided an efficient, fast image processing apparatus with low error probability for rapidly scrutinizing a digitized video image frame and processing said image frame to detect and characterize features of interest while ignoring other features of said image frame. There is further provided an efficient fast image processing method with low error probability for rapidly scrutinizing a digitized video image frame and processing said image frame to detect and characterize features of interest while ignoring other features of said image frame. In a first embodiment of the invention an image processing apparatus comprises an imaging device coupled to a digital electronic image processor. Video data from the imaging device is linked to a location data source. Objects of interest in a scene are identified by comparing computed Maximally Stable Extremal Regions (MSERs) of captured images with MSERs of images of objects contained in a object template database.

### REFERENCE TO RELATED APPLICATION

This application claims the priority of United Kingdom Patent Application No. GB0804466.1 filed on 11 Mar. 2008 by the present inventor.

### BACKGROUND OF THE INVENTION

The present invention relates generally to the field of automated image identification and in particular to the identification of signs depicted in video image frames.

There is a requirement for efficient methods for rapidly scrutinizing digitized video image frames and classifying and cataloging objects of interest depicted in said video frames. Many examples of methods developed for a range of applications are to be found in the patent literature. Prior art apparatus typically comprises a camera of known location or trajectory configured to survey a scene including one or more calibrated target objects, and at least one object of interest. Most prior art devices are used for capturing video data regarding an object operating in a controlled setting such as an industrial process line. Typically, said prior art devices are articulated along a known or pre-selected path such that information recorded by the device can be more easily interpreted from knowledge of the perspective of the camera and the known objects in the scene. The camera output data is processed by an image processing system configured to match objects in the scene to pre-recorded object image templates. The application to which the present invention is directed is concerned with the identification and classification of road signs. Several prior patents have been directed at sign detection.

U.S. Pat. No. 5,633,944 entitled “Method and Apparatus for Automatic Optical Recognition of Road Signs” issued May 27, 1997 to Guibert et al. and assigned to Automobiles Peugeot, discloses a system for recognizing signs wherein a source of coherent radiation, such as a laser, is used to scan the roadside. Such approaches suffer from the problems of optical and mechanical complexity and high cost.

U.S. Pat. No. 5,627,915 entitled “Pattern Recognition System Employing Unlike Templates to Detect Objects Having Distinctive Features in a Video Field,” issued May 6, 1997 to Rosser et al. and assigned to Princeton Video Image, Inc. of Princeton, N.J., discloses a method for rapidly and efficiently identifying landmarks and objects using templates that are sequentially created and inserted into live video fields and compared to a prior template(s). This system requires specific templates of real-world features and does not operate on unknown video data. Hence the invention suffers from the inherent variability of lighting, scene composition, weather effects, and placement variation from said templates to actual conditions in the field. The invention is also difficult to extend to the detection of new types of signs or signs from different countries.

U.S. Pat. No. 7,092,548 entitled “Method and apparatus for identifying objects depicted in a videostream” assigned to Facet Technology discloses techniques for building databases of road sign characteristics by automatically processing vast numbers of frames of roadside scenes recorded from a vehicle. By detecting differentiable characteristics associated with signs the portions of the image frame that depict a road sign are stored as highly compressed bitmapped files each linked to a discrete data structure including: sign type, sign location, camera reference and frame reference for each recognized sign bitmap. Frames lacking said differentiable characteristics are discarded. Sign location is derived from triangulation, correlation, or estimation on sign image regions. The novelty of the 548' patent lies in detecting objects without having to rely on continually tuned single filters and/or comparisons with stored templates to filter out objects of interest. However, the 548' patent does have the limitation that in any frame some differentiable feature (“sign-ness”) must exist in order for the frame to be retained for further analysis. The method disclosed in the 548' patent is limited to the detection of road signs and suffers from the need to process vast amounts of data.

The prior art suffers from the problems of high error probability and processing inefficiency. There is a need for an efficient fast image processing system with low error probability for rapidly scrutinizing a digitized video image frame and processing said image frame to detect and characterise features of interest while ignoring other features of each image frame. There is a further need to provide an efficient fast image processing method with low error probability for rapidly scrutinizing a digitized video image frame and processing said image frame to detect and characterise features of interest while ignoring other features of said image frame.

### SUMMARY OF THE INVENTION

The present invention has been developed to identify road signs of the type commonly used for traffic control, warning, and informational display. Although the following description describes the application of the invention in road sign identification it should be emphasized that the methods to be disclosed may also be applied to the detection of other types of visually displayed information such as company logos. It is an object of the present invention to provide an efficient fast image processing apparatus with low error probability for rapidly scrutinizing a digitized video image frame and processing said image frame to detect and characterise features of interest while ignoring other features of said image frame.

It is a further object of the present invention to provide an efficient fast image processing method with low error probability for rapidly scrutinizing a digitized video image frame and processing said image frame to detect and characterise features of interest while ignoring other features of said image frame.

In a first embodiment of the invention an image processing apparatus comprises an imaging device coupled to a digital electronic image processor. The imaging device further comprises an objective lens and an image-sensing array. The lens collects light over a field of view forming an image on the surface of the image-sensing array. Video data from the imaging device is conveyed via a communication link to the digital electronic image processor which comprises a frame buffer, an image processing module, a data output module, a first computer memory containing a precompiled sign image data base and a second computer memory area containing captured image data. The image processing module contains image processing algorithms implemented in either software or hardware. The data output module may be connected to a computer for further processing. Alternatively, the data output module or may provide data in a form suitable for use by an operator of the equipment. Typically, the image sensing array is based on CCD or CMOS technology.

In the most basic operational embodiment of the present invention, a vehicle-mounted single imaging device is directed toward the roadside. However, more efficient implementations would comprise several imaging devices wherein each overlaps other camera(s) and is directed toward a different field of view. The use of more than imaging device allows the use of well-known techniques of triangulation.

Desirably, the video frame data is linked to a location data source. Said location data source may provide absolute position via Global Positioning System (GPS) or Differential Global Positioning System (d-GPS) transponder/receiver, or relative position via Inertial Navigation System (INS) systems, or a combination of GPS and INS systems, etc such that the location of each identified object is known or at least susceptible to accurate calculation.

The present invention identifies road signs in a scene by comparing captured images likely to contain signs with images of signs contained in a sign template database. The scene depicted in any given video frame may contain several objects of interest disposed therein. Said images of signs may comprise one or more of mathematical models of signs, real captured images of signs or illustrations from publications.

In the first step of building the template database a Maximally Stable Extremal Region (MSER) is created for each type of sign to be included in the sign template database.

In the second step of building the template database affine transformations of the sign image elements are performed to allow orientation independent shape matching.

In the third step of building the template database the MSER images are normalized.

The next stages in the process are concerned with converting the data in a sample video frame captured by the imaging device into a form suitable for comparison with the images in the template database. Following the procedure used to create the template database the MSER of each image element in said sample video frame is computed and then the affine coordinate system of said image MSER is computed. Finally, a normalized image of each said image MSER is computed to provide an input image set.

In the next stage of the process each database MSER is compared with each image MSER in turn until at least one match is obtained. The matching process comprises the following steps

In a first step an input image MSER is selected from the input image set.

In a second step a template database image MSER is selected from the template database D.

In a third step an assumption is made that the selected input image MSER matches the selected template database image MSER.

In a fourth step a ‘sanity check’ is performed to determine whether the input image MSER and template database image MSER match falls within a predetermined threshold level. If the threshold condition is not met the template database image MSER is rejected and a new template database MSER is selected and the preceding steps are repeated. The sanity check comprises checking that the input image MSER and the template database image MSER are consistent in terms of at least one of orientation, size, position or skew.

In a fifth step the selected input image MSER and the selected template database MSER are correlated with the input image MSER and template database image MSER each being sampled at half resolution.

In a sixth step the selected input image MSER and the selected template database MSER are correlated with the input image MSER and template database image MSER each being sampled at full resolution.

In a seventh step a normalised correlation of the selected input image MSER and the selected template database MSER is performed with the input image MSER and template database image MSER each sampled at full resolution.

In each of the above correlation steps the template database MSER is rejected if the degree of correlation falls below a predetermined correlation level and a new template database MSER is selected and the preceding steps are repeated until the desired degree of correlation is achieved.

In an eighth step the shapes of the selected input image MSER and the selected template database image MSER are compared. The template database MSER is rejected if the shapes differ by a predetermined amount. A new template database MSER is selected and the above process is repeated until the desired degree of shape matching is achieved. Matching the shapes of the MSERs typically starts with the application of an edge finder algorithm. Shape matching is performed by computing distance metrics referred to the MSER centre of gravity or some other reference point. The basic procedure is to compare the outline of the template database image MSER with the outline of the selected input image MSER. This involves computing a distance transform for the template database image MSER and then computing the average distance for all the points lying on the perimeter of the input image MSER.

In a ninth step a match of the selected input image MSER and the selected template database image MSER is performed using an edge finder algorithm to determine the edges of each MSER. The database MSER is rejected if selected edge parameters of the MSERs differ by a predetermined amount. The preceding steps are then repeated until the desired degree of edge matching is achieved. Desirably the ninth step uses a more efficient edge match based on an iterative process in which the images are moved relative to each other until an optimal match is obtained.

In an tenth step a further ‘sanity check’ is performed to determine whether the input image MSER and template database image MSER are substantially the same. The template database MSER is rejected if the MSERs differ by a predetermined amount and the preceding steps are repeated until the desired match is achieved.

In an eleventh step repeat at least one of the above-described correlation processes is repeated using a higher correlation threshold.

In a twelfth step a comparison of the selected input image MSER and the selected template database image MSER is performed using an implementation of the Lucas-Kanade-Tomasi (KLT) algorithm. The template database MSER is rejected if the difference between the MSERs as determined by the KLT algorithm falls below a predetermined threshold. The preceding steps are then repeated until the MSERs are matched.

In a thirteenth step a colour comparison of selected input image MSER and the selected template database image MSER is performed. The template database MSER is rejected if the calorimetric properties of the MSERs differ by a predetermined amount. The preceding steps are then repeated until the desired colour match is achieved.

If the above steps are completed successfully the selected input image MSER and the selected template database image MSER are deemed matched. In the event of multiple matches being obtained the best match is selected.

In alternative embodiments of the invention a pre-recorded set of images, or a series of still images, or a digitized version of an original analog image sequence may be used to provide the input images. In certain embodiments of the invention photographs may be used to provide still images.

A more complete understanding of the invention can be obtained by considering the following detailed description in conjunction with the accompanying drawings wherein like index numerals indicate like parts. For purposes of clarity details relating to technical material that is known in the technical fields related to the invention have not been described in detail.

### BRIEF DESCRIPTION OF THE DRAWINGS

FIG. 1 is a schematic illustration of a first embodiment of the invention.

FIG. 2 is a schematic plan view of an operational embodiment of the invention.

FIG. 3 is a schematic plan view of an operational embodiment of the invention.

FIG. 4 depicts the process of computing the MSER of an image

FIG. 5 depicts MSERs formed using the process depicted in FIG. 4.

FIG. 6 depicts examples of MSERs associated with a typical road sign.

FIG. 7 is a flow diagram of an image processing procedure used in a first embodiment of the invention.

FIG. 8 is a flow diagram of an image processing procedure used in a first embodiment of the invention.

FIG. 9 is a flow diagram of an image processing procedure used in a further embodiment of the invention.

### DETAILED DESCRIPTION OF THE INVENTION

The present invention has been developed to identify road signs of the type commonly used for traffic control, warning, and informational display. Typically, such signs are disposed adjacent to a vehicle right-of-way and would normally be visible from said right-of-way. Desirably the signs are not obscured by other roadside installations and equipment. Advantageously, road signs typically follow certain rules and regulations with regard to size, shape, color, allowed color combinations, placement relative to vehicle pathways, and sequencing relative to other classes of road signs.

Prior art suffers from the problems of high error probability and processing inefficiency. There is a need for an efficient fast image processing system with low error probability for rapidly scrutinizing a digitized video image frame and processing said image frame to detect and characterise features of interest while ignoring other features of each image frame. Said errors typically involve false positive or negative sign matches. In typical practical embodiments it is desirable to minimize the number of negative sign matches, which tend to be more disruptive and expensive to correct. There is a further need for an efficient fast image processing method with low error probability for rapidly scrutinizing a digitized video image frame and processing said image frame to detect and characterise features of interest while ignoring other features of said image frame.

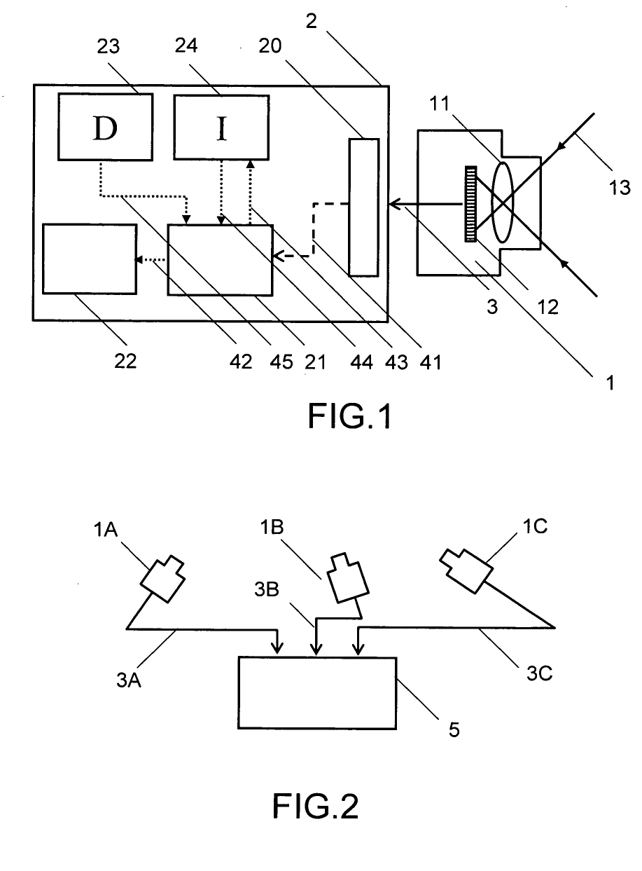

The apparatus for capturing and processing video data according to the principles of the invention is illustrated schematically FIG. 1. The apparatus comprises the imaging device 1 coupled to a digital electronic image processor 2. The imaging device 1 comprises the objective lens 11 and an image-sensing array 12. The lens collects light over a field of view generally indicated by 13 forming an image on the surface of the image-sensing array. The sensing array may be based on commonly used digital image sensors such as those based on CCD or CMOS technology. Video data from the imaging device is conveyed via a communication link 3 to the digital electronic image processor 2. Said digital electronic image processor comprises a frame buffer 20, an image processing module 21 containing image processing algorithms, a data output module 22, a first computer memory 23 containing a precompiled image data base D and a second computer memory area 24 containing processed captured image data I. The frame buffer is preferably capable of storing 24 bit color representative of the object represented in an RGB color space. Desirably, the number of significant color bits is five or greater. The data output module may be connected to a computer for further processing or may provide data in a form suitable for use by an operator of the equipment. The image processing module and data output module would typically employ digital imaging electronics and image processing algorithms. The invention does not rely on any particular architecture for implementing the modules illustrated in FIG. 1 or any specific type of electronic hardware or computer language for implementing the image processing algorithms, which will be described in more detail in the following. The digital electronic image processor 2 illustrated in FIG. 1 may be implemented in a single microprocessor apparatus, within a single computer having multiple processors, among several locally networked processors as in an intranet or via a global network of processors such as the Internet.

In alternative embodiments of the invention analysis of unprocessed or partially processed image data may be carried some time after the images are captured by storing image data in suitable data recording medium contained within or connected to the electronic image processor. For example, unprocessed or partially processed image data may be stored within a computer disc.

Alternatively unprocessed or partially processed image data may be transmitted to a remote processor.

The scene depicted in any given frame may contain several objects of interest disposed therein. Specifically, the input data comprises image frame data depict roadside scenes as recorded from a vehicle navigating said road. The output data comprises details of identified signs. The imaging devices will typically provide controls for adjusting focal length, aperture settings and other controls commonly used for manipulating input light. The imaging devices will also typically provide controls for adjusting video frame capture rates.

For the purposes of explaining the principles of the invention it will be assumed that a digital image capture apparatus such as the one illustrated in FIG. 1 is used to provide the input image data. Alternatively, a pre-recorded set of images, or a series of still images, or a digitized version of an original analog image sequence may be used to provide the input images. In certain embodiments of the invention photographs may be used to provide still images. Thus, the present invention may be practiced in real time, quasi real time, or some time after initial image acquisition. In the current embodiment of the invention frame rates are typically in the range of 1-2 seconds per frame. If the initial image acquisition is analog, it must be first digitized prior to subjecting the image frames to analysis in accordance with the invention herein described, taught, enabled, and claimed. In certain embodiments of the invention a visual display monitor may be coupled to the processing equipment used to implement the present invention in such a way that manual intervention and/or verification can be used to increase the accuracy of the ultimate output. In other embodiments of the invention the digital image processor may further comprise or operate in association with a synchronized database of characteristic type(s), location(s), number(s), damaged and/or missing objects.

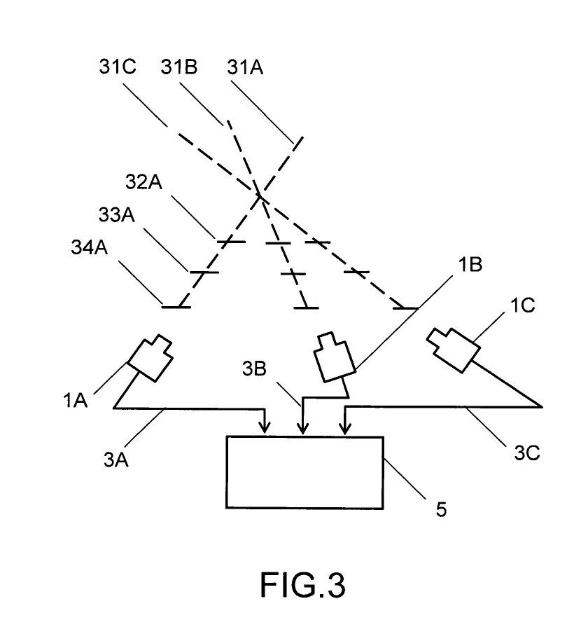

In the most basic operational embodiment of the present invention, a vehicle mounted single imaging device is directed toward the roadside. However, more efficient implements would comprise several imaging devices wherein each overlaps other camera(s) and is directed toward a different field of view. The use of more than imaging device allows the use of well-known techniques of triangulation and assuming a set of known (or automatically determined) camera parameters to determine the location of signs. For example, in the embodiment of the invention shown in FIG. 2 three imaging devices 1A,1B,1C are configured with their optical axes in three directions and connected to the electronic image processor 5 via data communication links indicated by 3A,3B,3C. The imaging devices capture images at a series of ranges along their respective optical axes as indicated schematically in FIG. 3. For example, in the case of the imaging device 1A images are captured at locations indicated by 32A,33B,33C. The invention is not restricted to any particular method of deriving location data. Other techniques for deriving location data known to those skilled in the art may be used. For example, if the pixel height or aspect ratio of confirmed objects is known, the location of the object can be deduced and recorded. Advantageously, location data is synchronized so that each image frame may be processed or reviewed in the context of the recording camera which originally captured the image, the frame number from which a bitmapped portion was captured, and the location of the vehicle or exact location of each camera conveyed by the vehicle.

Although in most practical implementation the imaging device used to implement the present invention will operate in the visible band, in certain applications it may be advantageous to operate in the other wavelength bands to take advantage of the higher visibility of signs in other wavelength bands. Said higher visibility may result from selective spectral characteristics of sign paints, for example. Non visible-band imaging devices for use with the present invention may operate in the near infrared, the thermal infrared bands or in the ultraviolet bands. In certain cases the imaging sensor may employ cameras operating in a range of wavelength bands to provide a wavelength-diversity imaging sensor. Scene illumination may be augmented with a source of illumination directed toward the scene of interest in order to diminish the effect of poor illumination and illumination variability among images of objects. However, the present invention is not dependent upon said additional source of illumination but if one is used the source of illumination should be chosen to elicit a maximum visual response from a surface of objects of interest.

Desirably, the portions of the image frame that depict a road sign are stored as highly compressed bitmapped files. Said bitmapped files may be linked to a discrete data structure containing one or more of the following memory fields: sign type, relative or absolute location of each sign, reference value for the recording camera, reference value for original recorded frame number for the bitmap of each recognized sign.

Desirably, the video frame data is linked to a source of location data for each imaging device. Said location data source may provide absolute position via Global Positioning System (GPS) or Differential Global Positioning System (d-GPS) transponder/receiver, or relative position via Inertial Navigation System (INS) systems, or a combination of GPS and INS systems such that the location of each identified object is known or at least susceptible to accurate calculation.

Typically, digital capture rates for digital moving cameras used in conjunction with the present invention are twenty frames per second. The invention is not restricted to any particular rate of video capture. Faster or substantially slower image capture rates can be successfully used in conjunction with the present invention, particularly if the velocity of the recording vehicle can be adapted for capture rates optimized for the recording apparatus.

The invention will be described in more detail with reference to the main image processing steps.

The present invention identifies road signs in a scene by comparing captured images likely to contain signs with images of signs contained in a database of reference images of road sign images. Said database, which will be referred to as a template database may comprise one or more of mathematical models of signs, real captured images of signs, or illustrations from publications such as the Traffic Signs Manual published by the United Kingdom Department for Transport. The Traffic Signs Manual gives guidance on the use of traffic signs and road markings prescribed by the Traffic Signs Regulations and covers England, Wales, Scotland and Northern Ireland.

Chapter 4 deals with warning signs. The current edition is dated 2004 (ISBN 0115524118). Chapter 5 deals with road markings. The current edition is dated 2003. (ISBN 011552479). Chapter 7 deals with the design of traffic signs. The current edition is dated 2003 (ISBN 011552480). Chapter 8 deals with temporary situations and road works and is in two parts: Part 1: Design and Part 2: Operations. The current edition of part 1 is dated 2006 (ISBN 011552738). The current edition of Part 2 is dated 2006 (ISBN 011552739). Said chapters may be purchased in hard copy from the Stationery Office.

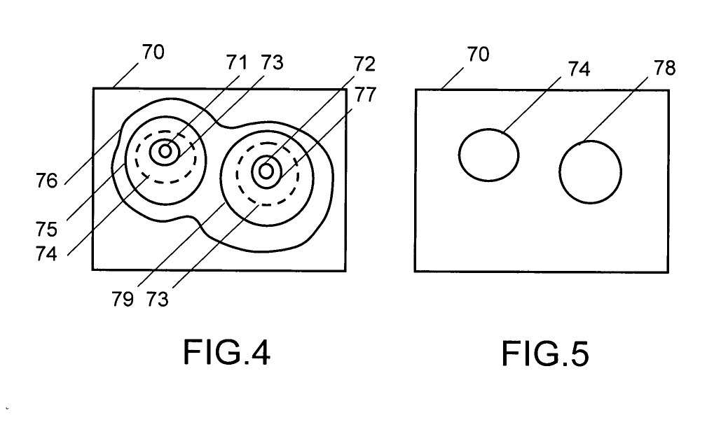

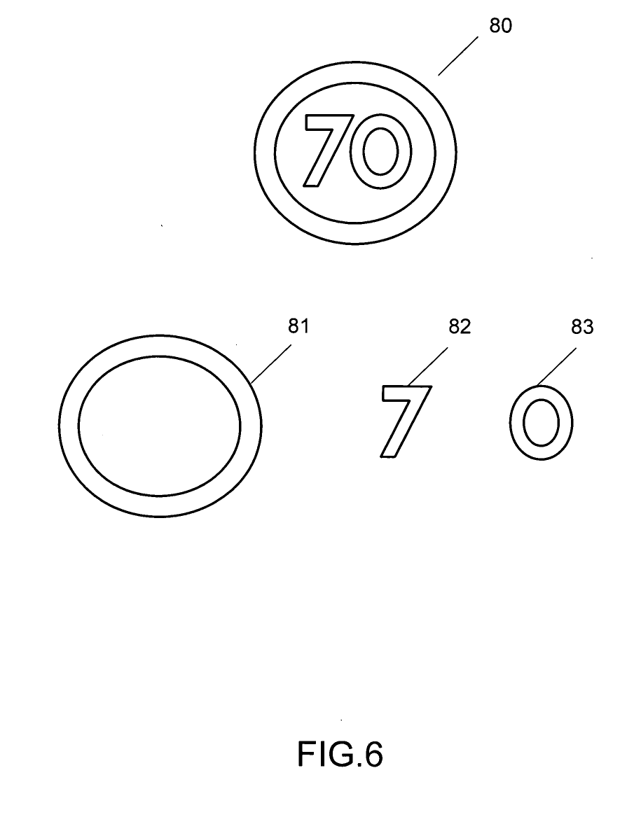

In the first step of building the template database a Maximally Stable Extremal Region (MSER) is created for each road sign image. An MSER is essentially an image containing intensity contours of sign features obtained by a process of density slicing. MSERs are regions that are either darker, or brighter than their surroundings, and that are stable across a range of thresholds of the intensity function. The principles of MSERs are illustrated in FIGS. 4-5. FIG. 4 illustrates the growth of MSER in an image region 70. The process of generating an MSER starts at some base threshold level (black or white) and proceeds by growing a region around a selected seed area such as the ones indicated by 71,72 in gray level steps such as the ones indicated by the contours 73-79 until a stable intensity contour indicated by the dashed contour lines 74,78 is achieved. FIG. 5 shows the resulting MSER image indicating stable intensity contours 74,78. FIG. 6 illustrates one example of a road sign indicated by 80 and typical MSER regions indicated by 81-83 that may be extracted using the above procedure. Typically, a MSER has resolution of 100×100 pixels. The basic principles of MSERs are discussed in articles such as the one by K Mikolajczyk, T Tuytelaars, C Schmid, A Zisserman, J Matas, F Schaffalitzky, T Kadir, and L van Gool entitled “A comparison of affine region detectors” published in the International Journal of Computer Vision, 65(7): 43-72, published in November 2005. Further details of MSERs are to be found in the article by J. Matas, O. Chum, U. Martin, and T Pajdla entitled “Robust wide baseline stereo from maximally stable extremal regions” in the Proceedings of the British Machine Vision Conference, volume 1, pages 384-393, published in 2002.

In the second step of building the template database affine transformations of the sign image elements are performed to allow orientation independent image matching. The principles of affine transformations are well known. An affine transformation is an important class of linear 2-D geometric transformations which maps variables, such as pixel intensity values located at position in an input image, for example, into new variables (in an output image) by applying a linear combination of translation rotation scaling and/or shearing (i.e. non-uniform scaling in some directions) operations. In basic terms, an affine transformation is any transformation that preserves co-linearity (ie all points lying on a line initially still lie on a line after transformation) and ratios of distances (e.g., the midpoint of a line segment remains the midpoint after transformation). In many imaging systems, detected images are subject to geometric distortion introduced by perspective irregularities wherein the position of the camera(s) with respect to the scene alters the apparent dimensions of the scene geometry. Applying an affine transformation to a uniformly distorted image can correct for a range of perspective distortions by transforming the measurements from the ideal coordinates to those actually used.

In the third step of building the template database the MSER images are normalized. Essentially the normalization procedure comprises subtracting the mean pixel intensity value of all pixels in the MSER from each pixel and dividing the result by the standard deviation of the pixels in the MSER.

The next stage in the process is concerned with converting the data in a sample video frame captured by the imaging device into a form suitable for comparison with the images in the template database. Following the procedure used to compute the template database the MSER and the affine coordinate system of said image MSER are computed in turn. Finally, a normalized image of each said image MSER is computed to provide an image set I.

In the next stage of the process each database MSER is compared with each image MSER in turn until at least one match is obtained. The matching process comprises the following steps

In a first step an input image MSER is selected from the image set I.

In a second step a template database image MSER is selected from the database D.

In a third step an assumption is made that the selected input image MSER matches the selected template database image MSER.

In a fourth step a ‘sanity check’ is performed to determine whether the input image MSER and template database image MSER match falls within a predetermined threshold level. If the threshold condition is not met the template database image MSER is rejected and a new template database MSER is selected and the preceding steps are repeated. For the purposes of understanding the invention a sanity check means checking that the input image MSER and template database image MSER are consistent in terms of at least one of orientation; size, position or skew. The sanity check is based on simple assumptions about the geometry of signs. For example, an object characterised by ninety-degree angles may be a sign. To give another example, it is reasonable to assume that signs will typically be square, round or rectangular. A sanity check may apply simple tests such as, for example: is the image MSER bigger than 20×20 pixels in size; is the image MSER smaller than one third of the image size; and other similar tests.

There now follows a series of correlations at progressively higher resolutions.

In a fifth step the selected input image MSER and the selected template database MSER are correlated with the input image MSER and template database image MSER each being sampled at half resolution.

In a sixth step the selected input image MSER and the selected template database MSER are correlated with the input image MSER and template database image MSER each being sampled at full resolution.

5 In a seventh step perform a normalised correlation of the selected input image MSER and the selected template database MSER is performed with the input image MSER and template database image MSER each sampled at full resolution.

In each of the above correlation steps the template database image MSER is rejected if the degree of correlation falls below a predetermined correlation level and a new template database image MSER is selected and the preceding steps are repeated until the desired degree of correlation is achieved.

The above described correlation processes are essentially pixelwise correlations between the template database and input image MSERs. It should be noted that the present invention does not rely on any particular correlation algorithm or implementation scheme thereof. A variety of correlation methods known to those skilled in the art of image processing may be used. Examples of correlation methods are given in standard references on computer vision such as the book by V. S. Nalwa entitled “A guided tour of computer vision” published in 1994 by Addison-Wesley Longman Publishing Co., Inc. Boston, Mass.

In an eighth step the shapes of the selected input image MSER and the selected template database image MSER are compared. The database MSER is rejected if the shapes differ by a predetermined amount. A new database MSER is selected and the above process is repeated until the desired degree of shape matching is achieved. Shape matching is carried out using distance metrics referred to the MSER centre of gravity or some other reference point. The basic procedure is to compare the outline of the template database image MSER with the outline of the selected input image MSER. This involves computing a distance transform for the template database image MSER and then computing the average distance for all the points lying on the perimeter of the input image MSER.

In a ninth step a match of selected input image MSER and the selected template database image MSER is performed using an edge finder algorithm to determine the edges of each MSER. The database MSER is rejected if selected edge parameters of the MSERs differ by a predetermined amount. The preceding steps are then repeated until the desired degree of edge matching is achieved. Desirably the ninth step uses a more efficient edge match using an iterative process in which the images are moved relative to each other until an optimal match is obtained. An exemplary edge finding algorithm for use in the above steps is the well known Canny edge detection algorithm which is described in the article entitled “A computational approach to edge detection” in IEEE Transactions on Pattern Analysis and Machine Intelligence, Volume 8, Issue 6, pages: 679-698 published in 1986. Distance transforms suitable for application in the present invention are discussed in the book entitled “Computer Vision, Graphics, and Image Processing”, Volume 34, Issue 3 (June 1986) Pages: 344-371 published in 1986.

In an tenth step a further ‘sanity check’ is performed to determine whether the input image MSER and template database image MSER are substantially the same. The template database image MSER is rejected if the MSERs differ by a predetermined amount and the preceding steps are repeated until the desired match is achieved.

In a eleventh step repeat at least one of the above-described correlation processes is applied using a higher correlation threshold.

In a twelfth step a comparison of selected input image MSER and the selected template database image MSER is performed using an implementation of the Kanade-Lucas-Tomasi feature tracker algorithm to find the best match between two images. An implementation of the algorithm written in the C programming language is currently widely used by the computer vision community. The source code is in the public domain, available for both commercial and non-commercial use. Further details of the KLT algorithm are provided in a paper by Bruce D. Lucas and Takeo Kanade entitled “An Iterative Image Registration Technique with an Application to Stereo Vision” published in International Joint Conference on Artificial Intelligence, pages 674-679, 1981. The template database image MSER is rejected if the difference between the MSERs as determined by the KLT algorithm falls below a predetermined threshold. The preceding steps are then repeated until the MSERs are matched.

As an alternative to using the KLT algorithm the invention may be applied using alternative algorithms based on computing local gradient and image differences to perform image matching.

In a thirteenth step a colour comparison of selected input image MSER and the selected template database image MSER is performed. The template database image MSER is rejected if the calorimetric properties of the MSERs differ by a predetermined amount. The preceding steps are then repeated until the desired colour match is achieved.

If the above steps are completed successfully the selected input image MSER and the selected template database image MSER are deemed matched. In the event of multiple matches being obtained the best match is selected.

The above steps from one to fourteen have been ranked in terms of efficiency and speed starting with lowest level image operations first. In alternative embodiments of the invention the order of certain steps in the above series may be interchanged.

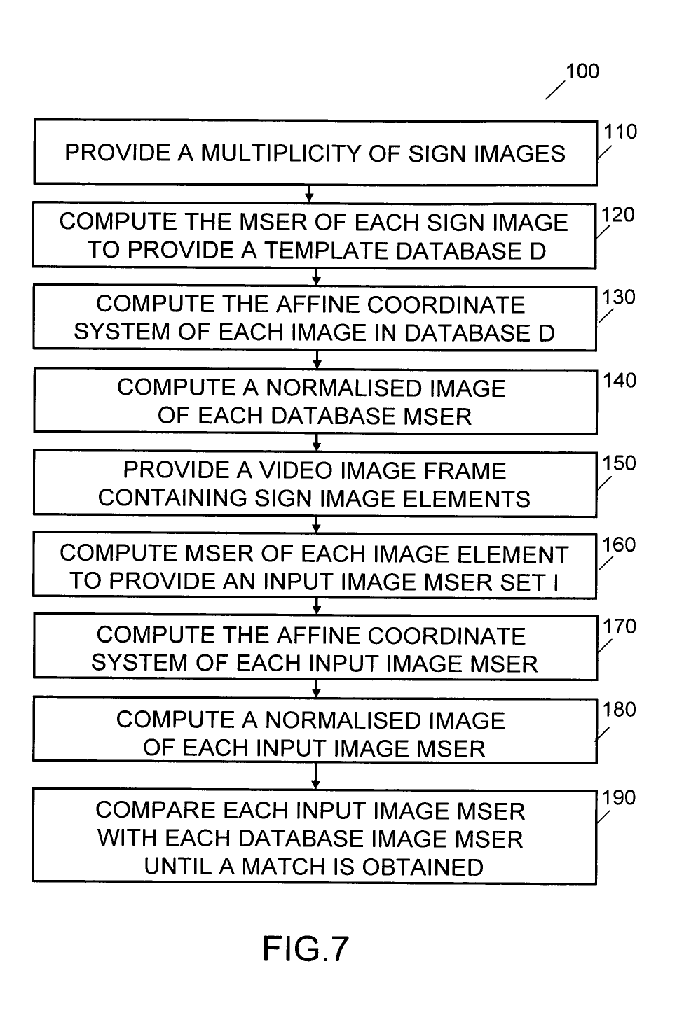

A method of detecting objects in an image in accordance with the basic principles of the invention is shown in FIG. 7. Referring to the flow diagram 100, we see that the said method comprises the following steps.

At step 110 a multiplicity of sign images is provided.

At step 120 the MSER of each sign image is computed to provide a template database D.

At step 130 the affine coordinate system of each said database MSER is computed.

At step 140 a normalised image of each said template database MSER is created.

At step 150 a video image frame containing image elements is provided.

At step 160 the MSER of each said image element is computed to provide an input image MSER set I.

At step 170 the affine coordinate system of said input image MSERs is computed.

On completion of step 170 a set I of input image MSERs is available for matching with the MSERs stored in the template database.

At step 180 a normalised image of each said input image MSER is computed to provide the image set I

At step 190 each database MSER is compared with each input image MSER in turn until at least one match is obtained, with the best match being selected in the case of multiple matches occurring.

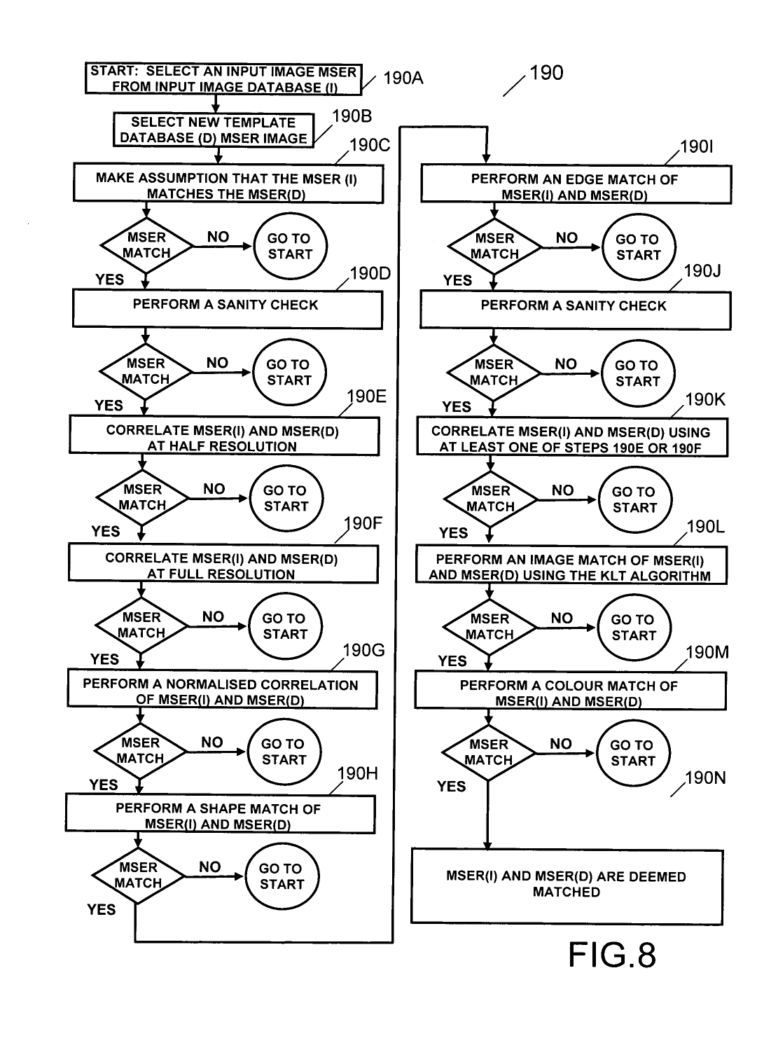

Turning now to FIG. 8 and referring to the flow diagram provided therein we see that the matching process of step 190 comprises the following steps:

At step 190A select an input image MSER (referred to as MSER(I) in FIG. 8) from the image set I.

At step 190B select an MSER (referred to as MSER(D) in FIG. 8) from the template database D.

At step 190C make the assumption that the selected input image MSER matches the selected template database image MSER.

At step 190D perform a sanity check to determine whether the input image MSER and template database image MSER match falls within a predetermined threshold level, rejecting the template database image MSER if the threshold is not met and then repeating the previous steps starting from step 190B.

At step 190E perform a correlation of the selected input image MSER and the selected database image MSER with the input image MSER and template database image MSER each sampled at half resolution, rejecting the database MSER if the degree of correlation falls below a predetermined correlation level and then repeating the previous steps starting from step 190B.

At step 190F perform a correlation of the selected input image MSER and the selected database MSER with the input image MSER and template database image MSER each sampled at full resolution, rejecting the database MSER if the degree of correlation falls below a predetermined correlation level and then repeating the previous steps starting from step 190B.

At step 190G perform a normalised correlation of the selected input image MSER and the selected database MSER with the input image MSER and template database image MSER each sampled at full resolution, rejecting the database MSER if the degree of correlation falls below a predetermined correlation level and then repeating the previous steps starting from step 190B.

At step 190H check that the shape of the selected input image MSER and the selected template database image MSER are substantially the same, rejecting the database MSER if the shapes differ by a predetermined amount and then repeating the previous steps starting from step 190B.

At step 190I perform a match of selected input image MSER and the selected template database image MSER using an edge finder algorithm to determine the edges of each MSER, rejecting the database MSER if selected edge parameters of the MSERs differ by a predetermined amount and then repeating the previous steps starting from step 190B.

At step 190J perform a sanity check to determine whether the input image MSER and template database image MSER are substantially the same, rejecting the database MSER if the MSERs differ by a predetermined amount and then repeating the previous steps starting from step 190B.

At step 190K repeat at least one of steps 190E, 190F applying a higher correlation threshold.

At step 190L perform a comparison of selected input image MSER and the selected template database image MSER using an implementation of the KLT algorithm, rejecting the database MSER if the difference between the MSERs falls below a predetermined threshold and then repeating the previous steps starting from step 190B.

At step 190M perform a colour comparison of selected input image MSER and the selected template database image MSER, rejecting the database MSER if the colorimetric properties of the MSERs differ by a predetermined amount and then repeating the previous steps starting from step 190B.

At step 190N the selected input image MSER and the selected template database image MSER are deemed matched

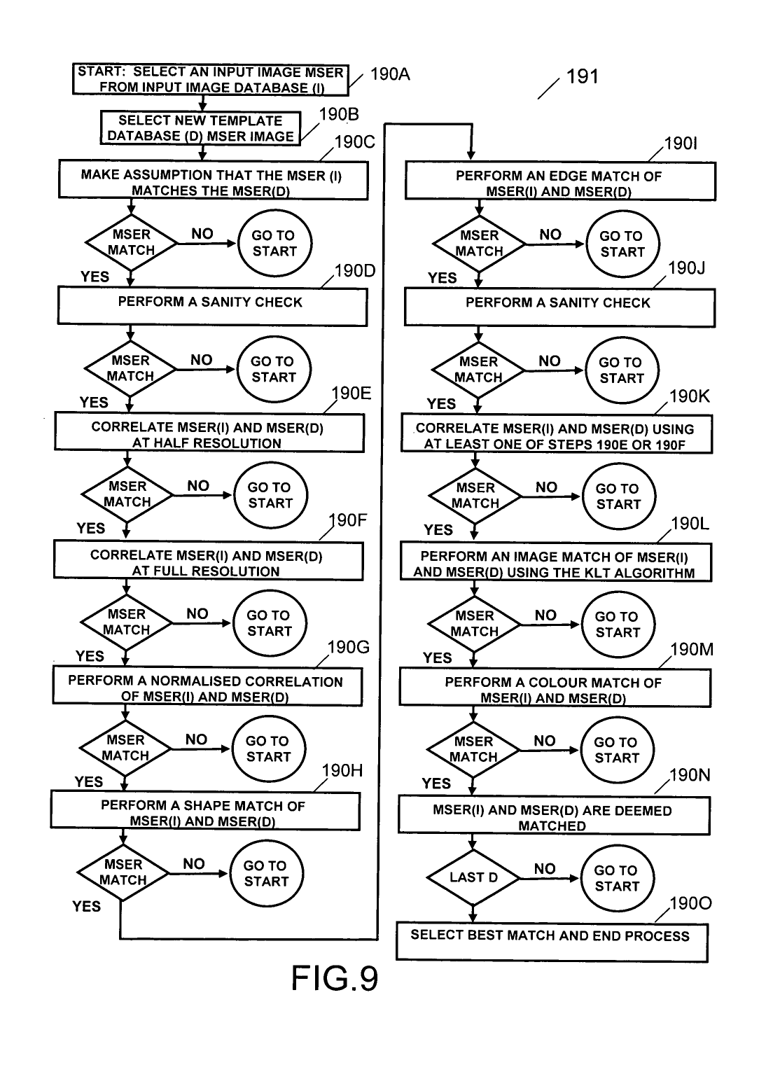

In the event of multiple matches being obtained the best match is selected. FIG. 9 is a flow chart, which is identical to the one shown in FIG. 8 with an additional step 190O. At step 190O the input image MSER and template database image MSER exhibiting the best match are selected and the process ends.

Steps 190A-190N are ranked in terms of efficiency and speed starting with lowest level image operations first. In alternative embodiments of the invention the order of certain steps in the above series may be interchanged.

In a further embodiment of the invention at least one of the steps in the sequence 190A-190N may be repeated for another relative orientation of the selected input image MSER and the selected template database image MSER with tighter constraints being applied at each step.

In a further embodiment of the invention at least one of the steps in the sequence 190A-190N may be repeated for another correlation at a lower threshold.

In further embodiments of the inventions further processing steps may be added at any point in the sequence 190A-190N. For example a further step may be carried out after step 190N in which a side-by-side histogram match of selected input image MSER and the selected template database image MSER is performed with the image contrasts of each MSER adjusted to match intensity. Advantageously, such a steps would be followed by further image correlation steps of the type described above.

In the above discussion of the invention the image matching process relies on selecting an input image MSER and performing comparisons with each database MSER in turn until a match is achieved. In alternative embodiments of the inventions the matching processing may be based on selecting template database image MSERs and performing comparisons with each input image MSER in turn until a match is achieved. Such a procedure may be advantageous in applications where large numbers of signs are likely to be found in a scene.

A certain degree of pre-processing of the input images will normally be required to correct for known camera irregularities such as lens distortion, color gamut recording deficiencies, lens scratches, etc. These may be determined by recording a known camera target. In the case of vehicle-mounted cameras, vehicle motion will inevitably result in a certain degree of blurring. A sharpening filter, which seeks to preserve edges, is preferably used to overcome this problem. Desirably, such a filter would employ a prior knowledge of the motion flow of pixels, which will remain fairly constant in both direction and magnitude.

It might be desirable to correct the input images for large variations in exposure. This ensures that dark areas of the image (typically shadows) are not under-exposed and light areas of the image are not over-exposed. For this, the Contrast Limited Adaptive Histogram Equalization (CLAH) algorithm is used. The implementation follows the publication entitled “Contrast limited adaptive histogram equalization” in Graphics Gems IV, pages 474-485, ISBN 0-12-336155-9.

The present invention creates at least a single output for each instance where an object of interest was identified. In further embodiments of the invention the output may comprise one or more of the following: orientation of the road sign image, location of each identified object, type of object located, entry of object data into an GIS database, and bitmap image(s) of each said object available for human inspection (printed and/or displayed on a monitor), and/or archived, distributed, or subjected to further automatic or manual processing.

Sign recognition may be assisted by a number of characteristics of road signs. For example, road signs benefit from a simple set of rules regarding the location and sequence of signs relative to vehicles on the road and a very limited set of colours and symbology etc. The aspect ratio and size of a potential object of interest can be used to confirm that an object is very likely a road sign.

It will be clear from that by carefully optimizing the above described image processing algorithms the present invention may overcome the problems of partially obscured signs, skewed signs, poorly illuminated signs, signs only partially present in an image frame, bent signs, and ignores all other information present in the input image set.

The present invention is not restricted to the detection of road signs. The basic principles of the invention may also be used to recognize, catalogue, and organize searchable data relating to signs adjacent to railways road, public rights of way, commercial signage, utility poles, pipelines, billboards, man holes, and other objects of interest that are amenable to video capture techniques.

The present invention may be applied to the detection of company logos, signs used in railways, airports and industrial plant and many other types of information displays that can be characterised by an image template. The invention may also be applied to the detection of other types of objects in scenes where the objects can be characterised by an image template as described above. For example, the invention may be applied to industrial process monitoring, image inspection for security applications and traffic surveillance and monitoring.

Although the invention has been described in relation to what are presently considered to be the most practical and preferred embodiments, it is to be understood that the invention is not limited to the disclosed arrangements, but rather is intended to cover various modifications and equivalent constructions included within the spirit and scope of the invention without departing from the scope of the following claims.

What is claimed:

1. A method of detecting signs in an image comprising the steps of:
a) providing a multiplicity of sign images;
b) computing the MSER of each said sign image to provide a template database;
c) computing the affine coordinate system of each said template database image MSER;
d) computing a normalized image of each said template database image MSER;
e) providing a digitized input image believed to contain sign image elements;
f) computing the MSER of each said sign image element to provide a set of input image MSERs;
g) computing the affine coordinate system of each said input image MSER;
h) computing a normalized image of each said input image MSER;
i) comparing each template database image MSER with each input image MSER in turn until at least one match is obtained with the best match being selected in the case of multiple matches occurring.

2. The method of claim 1 wherein the image matching process of step (i) comprises the steps of:
(i) selecting an input image MSER;
(ii) selecting an image MSER from said template database;
(iii) making the assumption that said selected input image MSER matches said selected template database image MSER;
(iv) performing a first sanity check to determine whether the degree of match between said input image MSER and said template database image MSER falls below a predetermined threshold level, wherein said template database image MSER is rejected if said threshold is not met;
(iv) correlating said selected input image MSER and said selected template database image MSER, wherein said input image MSER and said template database image MSER are each sampled at a first resolution, wherein said template database image MSER is rejected if the degree of correlation falls below a predetermined correlation level;
(v) correlating said selected input image MSER and said selected template database image MSER wherein said input image MSER and said template database image MSER are each sampled at a second resolution, wherein said template database image MSER is rejected if the degree of correlation falls below a predetermined threshold level;
(vii) performing a normalised correlation of said selected input image MSER and said selected template database image MSER, wherein said input image MSER and said template database image MSER are each sampled at full resolution, wherein said template database image MSER is rejected if the degree of correlation falls below a predetermined threshold level;
(vi) determining whether the shape of said selected input image MSER and said selected template database image MSER are substantially the same, wherein said template database image MSER is rejected if the degree of similarity of said shapes falls below a predetermined threshold level;
(vii) performing a match of said selected input image MSER and said selected template database image MSER using an edge finder algorithm to determine the edges of each MSER, wherein said template database image MSER is rejected if the degree of edge matching of the MSERs falls below a predetermined threshold level;
(x) performing a second sanity check to determine whether said input image MSER and said template database image MSER are substantially the same, wherein said template database image MSER is rejected if the difference between the MSERs falls below a predetermined threshold level;
(viii) repeating at least one of steps (iv)-(vii) applying a higher correlation threshold;
(ix) performing a comparison of said selected input image MSER and said selected template database image MSER using an implementation of the KLT algorithm, wherein said template database image MSER is rejected if the match between the MSERs falls below a predetermined threshold; and
(x) performing a colour comparison of said selected input image MSER and said selected database MSER, wherein said template database image MSER is rejected if the colorimetric match of the MSERs falls below a predetermined threshold level,
wherein said first and second sanity check each comprises checking that said input image MSER and said template database image MSER are consistent in terms of at least one of orientation, size, position or skew.
wherein following any step in which said template database image MSER is rejected the preceding steps from step (ii) are repeated.

3. The method of claim 1 wherein said input image is a video frame provided by at least one video camera.

4. The method of claim 1 wherein said input image is a frame from a live video stream.

5. The method of claim 2 wherein said input image is a frame from a prerecorded video stream.

6. The method of claim 1 wherein said input image is recorded photographically.

7. The method of claim 1 wherein said input image is provided by at least one vehicle mounted video camera.

8. The method of claim 2 wherein a human operator performs at least one of said first and second sanity checks.

9. The method of claim 1 wherein said input image forms part of a live video stream delivered at twenty frames per second.

10. The method of claim 1 wherein said video frame data is linked to data from at least one of a Global Positioning System or an Inertial Navigation System.

11. The method of claim 2 wherein a further step comprises performing a side-by-side histogram match of said selected input image MSER and said selected template database image MSER is performed with the image contrasts of each MSER adjusted to match intensity.

12. The method of claim 1 wherein said input image frame is provided by at least one video camera and techniques of triangulation are used to determine the location of signs.

13. The method of claim 2 wherein a portion of the sequence of steps (ii) to (x) comprising at least one step is repeated after applying a relative rotation of said selected input image MSER and said selected template database image MSER

14. The method of claim 2 wherein a portion of the sequence of steps (ii) to (x) comprising at least one step is repeated after applying a relative displacement of said selected input image MSER and the selected template database image MSER

15. The method of claim 2 wherein a further correlation of said selected input image MSER and said selected template database image MSER is performed after any step in the sequence (ii) to (x), wherein the template database image MSER is rejected if the degree of correlation falls below a predetermined threshold.

16. The method of claim 2 wherein said first resolution corresponds to half resolution.

17. The method of claim 2 wherein said second resolution corresponds to full resolution.
